(19) United States
(12) Patent Application Publication
(10) Pub. No.: US 2006/0110094 A1
(43) Pub. Date: May 25, 2006

(54) Bidirectional electro-optical device for coupling light-signals into and out of a waveguide

(76) Inventors: Bernhard Bachl, Falkensee (DE); Peter Brockhaus, Berlin (DE)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 10/993,313

(22) Filed: Nov. 19, 2004

(51) Int. Cl. G02B 6/12

(52) U.S. Cl. 385/14

(57) ABSTRACT

The invention relates to an optoelectronic module for coupling light signals into and out of an optical waveguide. The module has a carrier having at least a first side, a light transmitter for emitting light signals, which is arranged on the carrier, a receiver for detecting light signals, which is arranged on the carrier, and a beam-shaping element for coupling light signals of the laser diode out of the module and for coupling light signals into the receiver. The light transmitter and the receiver are both arranged on the first side of the carrier, a shielding means serving to shield the receiver from optical and/or electrical interference signals. As a result, a bidirectional optoelectronic module is provided which is distinguished by signal conversion that is as precise as possible and, at the same time, is comparatively cost-effective in terms of production.

The invention relates to an optoelectronic module for coupling light signals into and out of an optical waveguide. In particular, the invention relates to an optoelectronic micromodule arrangement that is employed in the field of micromodule technology.

### BACKGROUND OF THE INVENTION

Bidirectional optoelectronic transmitting and receiving modules (transceivers) which can both transmit and receive optical signals are known. Bidirectional modules based on micromodule technology are used in particular as TO components (TO=transistor outline). A bidirectional transmitting and receiving module transmits light having a first wavelength and detects light having a second wavelength. A preferred, but not exclusive, area of use is WDM (wavelength division multiplex/demultiplex) communications.

It is furthermore known to use, for a compact construction, bidirectional transmitting and receiving modules that use a common carrier for the light transmitter and the receiver. In order, in this case, to prevent the receiver from receiving scattered light transmitted by the light transmitter, essentially two types of construction of bidirectional transmitting and receiving units are known.

WO 2004/051894 A1 discloses a bidirectional transmitting and receiving module in which a light transmitter is fixed on the top side of a carrier and a receiver is arranged on the opposite underside of the carrier. The transmitting element emits light signals parallel to the top side, which light signals are deflected such that they run perpendicular to the surface of the carrier and are coupled into an optical waveguide. Light signals coupled out of the optical waveguide penetrate the carrier in the perpendicular direction and are detected by the receiver on the underside of the carrier.

A different form of configuration of a bidirectional module uses so-called PLC technology. In this case, on the carrier, optical waveguides are laid directly up to the light transmitter and directly up to the receiver in order thereby to reduce scattered light (so-called optical crosstalk). In this embodiment light transmitter and receiver can also be arranged on the same side of the carrier. In this case, however, it is not possible to first incorporate the module and then align it in such a way as to optimize the coupling between an optical waveguide and the module, since the optical waveguides are already integrated into the carrier. Furthermore, it is necessary to use a plurality of optical waveguides.

There is a need for a bidirectional optoelectronic module which is distinguished by signal conversion that is as precise as possible and, at the same time, is as cost-effective as possible in terms of production.

### SUMMARY OF THE INVENTION

In accordance with the present invention, the optoelectronic module has a carrier having at least a first side, on which both a light transmitter for emitting light signals and a receiver for detecting light signals are arranged. A first light-shaping element (e.g. a microlens, a mirror, prism, etc.) serves for coupling light signals of the light transmitter out of the module and into an optical waveguide, and at the same time for coupling light signals out of the optical waveguide into the receiver. In this case, the coupling between the first light-shaping element and the receiver does not have to be effected directly, but rather may be effected for example by means of deflection mirrors and lenses. The light transmitter and also the receiver are both arranged on the same side of the carrier. A shielding means is provided in order to shield the carrier from optical and/or electrical interference signals.

An essential problem in the provision of bidirectional optoelectronic modules is so-called crosstalk, that is to say undesirable interference or scattered signals that are not intended to be detected by the receiver but are present. The main source for optical crosstalk is the light transmitter, which may be formed e.g. as a laser diode or LED. If light from the light transmitter is not radiated directly into an optical waveguide (as in the case of PLC technology) rather the signals are first coupled in via light-shaping elements as coupling means, optical interference signals occur as a result of scattering and reflection at optical diffraction, reflection and coupling means. As a result of the electrical modulation of the transmitter diode for transmission of light signals to be transmitted, an electromagnetic alternating field is furthermore generated which would induce electrical interference signals in the (unprotected) receiver (electrical crosstalk). The light transmitter is not the only source that causes optical and/or electrical interference signals, but is generally the strongest.

According to the invention, the shielding means protects the receiver by shielding it from optical and/or electrical interference signals, that is to say either absorbing and/or reflecting the interference signals.

Thus, in contrast to the prior art, the carrier no longer has to be formed in transparent fashion for the light signals, which reduces the costs for the carrier. Receiver and light transmitter are arranged on the same side of the carrier, it not being necessary to lay optical waveguides on the carrier up to the light transmitter and receiver. At the same time, the coupling means make it possible to couple the outgoing signals into a single-mode fiber and to optimize the coupling by active alignment of the light-shaping element. In the case of PLC technology, this can only be realized with very great difficulty technically since optical waveguides are laid through trenches formed on the carrier up to the transmitter and receiver, respectively, into which coupling is effected directly on the carrier. Alignment is very difficult to realize in this case.

In a preferred embodiment, the shielding means is formed as a separate component and arranged on the first side of the carrier. In this case, it encloses the receiver in such a way that the receiver is arranged within the shielding means, that is to say is surrounded by the shielding means like being surrounded by a housing. In this case, it is formed in box-shaped or parallelepipedal fashion, by way of example.

The shielding means is advantageously formed in micromechanically etched fashion. In this case, a multiplicity of shielding means joined together in the wafer are etched, for example, in the form of parallelograms.

Particularly preferably, the shielding means is formed in hollow fashion and defines a three-dimensional spatial region that is bounded by the shielding means and the carrier. It has a taplike form, by way of example, and is arranged on the submount in such a way that the receiver is positioned within the spatial region defined by the shielding means and the submount bounds one or more sides of the spatial region not bounded by the shielding means. As a result, the receiver is shielded on all sides either by the shielding means or by the carrier. The shielding effect is maximized if the receiver is enclosed by the shielding means as far as possible on all sides.

Particularly preferably, the shielding means is formed as a Faraday cage and the receiver is arranged within the Faraday cage. The Faraday cage protects the receiver in particular from electrical interference signals, which cannot pass into the interior of the Faraday cage. This prevents induction of electrical signals on the basis of electromagnetic waves that arise during the modulation of the laser diode, by way of example. For this purpose, the shielding means has been metallized in a coating installation, by way of example.

In one embodiment, the shielding means has a coupling-in opening through which light signals from the first light-shaping element are coupled into the receiver. In this case, the coupling-in opening is preferably the only opening of the shielding means and thus the only possible entry or exit for electromagnetic radiation. The coupling-in opening is for example sawn into the shielding means by means of a wafer saw.

The module advantageously has a second light-shaping element, in particular a further microlens, which is arranged in the beam path between the first light-shaping element and the receiver in such a way that it couples light signals passing from the first light-shaping element to the receiver onto an optically active area of the receiver. Furthermore, it is also possible to provide a third light-shaping element for the light transmitter, which images the signals coupled out of the light transmitter onto the first light-shaping element, it being possible for further optical elements to be arranged between the beam-shaping elements. All the beam-shaping elements are preferably formed as microlenses made of silicon.

The side of the second light-shaping element that is remote from the receiver is advantageously provided with an optical filter, which filters out scattered light of the light transmitter from the receiver. However, the optical filter transmits the signals to be received, which are coupled into the receiver from the optical waveguide via the first light-shaping element and via the second light-shaping element. The optical filter is thus transmissive either only at a specific angle or only for the wavelength of the light signals to be received.

In one embodiment, a layer (blocking layer) that is nontransparent to the light of the light transmitter is formed on at least one side of the carrier. Preferably, the carrier has such a blocking layer both on the first side with the receiver and the laser diode and on the opposite side. The blocking layer is nontransparent at least to the wavelength at which the light transmitter emits light signals. The blocking layer protects the receiver from detecting light signals that have possibly been scattered or sent through the carrier. Consequently, not only the directions that are shielded by the shielding means outside the carrier are protected from interfering signal influence, but also the path via the carrier. The blocking layers may also be formed in metallized fashion, in which case they block both optical and electrical interference signals.

Preferably, apart from the first light-shaping element, all the components of the module that are required for coupling in and out are arranged on the same, first side of the carrier. The components thus comprise, by way of example, the light transmitter, the receiver, a light transmitter coupling means, a receiver coupling means and a beam splitter.

Particularly preferably, the first light-shaping element is arranged on an end side of the same carrier on which the light transmitter and the receiver are also arranged. An additional carrier such as a deflection prism, by way of example, on which the first light-shaping element is arranged in embodiments known heretofore is thereby obviated, which significantly reduces the production costs for the module.

The module is advantageously formed in a manner free of waveguides. Thus, PLC technology is not used, but the alignability of the coupling means is obtained despite the arrangement of light transmitter and receiver on one side of the carrier.

This means, inter alia, that a free-radiating region is present in the beam path between the light transmitter and the first light-shaping element and/or between the receiver and the second light-shaping element.

In a particularly preferred embodiment, the module can be coupled to an optical waveguide in such a way that the beam path runs essentially rectilinearly between the light transmitter and the first light-shaping element (and, if appropriate, moreover, up to the optical waveguide). The use of a deflection means such as a mirror thereby becomes superfluous. The emission direction of the light transmitter thus essentially correlates with the coupling-in direction into the optical waveguide. In this case, it must be taken into consideration that the light signals from the laser are not coupled exactly rectilinearly into the optical waveguide, but rather at a squint angle of 1° to 3° in order to avoid interference with the laser by retroreflected light. The squint angle can be set through active alignment of the microlens.

As an alternative to this, the detection direction of the receiver may also correlate with the coupling-out direction from the optical waveguide. In this case, the module can be coupled to the optical waveguide in such a way that the beam path runs essentially rectilinearly between the receiver and the first light-shaping element (and, if appropriate, moreover with the optical waveguide).

In an advantageous manner, the light transmitter transmits light having a first wavelength, while the receiver detects light having a second wavelength that differs from the first. In this case, a wavelength-selective beam splitter is furthermore provided, which reflects either the emitted wavelength or the wavelength to be received. The light transmitter and the receiver are then arranged on the carrier in such a way that the beam paths assigned to them, that is to say the beam paths to be detected and to be transmitted, run at an angle of approximately 90° with respect to one another at the location of the beam splitter. However, other arrangements with angles of between 40° and 140° are also possible. In this case, the beam splitter may be arranged in a groove of the carrier.

As an alternative to a wave-selective beam splitter, it is also possible to use a partly transmissive filter, that is to say, for example, a 3 DB or 5 DB filter or the like. The transmitter then transmits light signals at the same wavelength at which the receiver receives light signals. As a result of the filter's property of transmitting one portion of the light signals and reflecting another portion, in this embodiment the signal transmission/detection is qualitatively not as good as with a WDM filter. In return, however, the costs of such a construction are lower.

Preferably, a carrier is used which is nontransparent to the light signals to be transmitted and to be received. This enables particularly good shielding of the signals and prevents interference signal transport through the carrier. In this case, the first light-shaping element can advantageously be actively aligned, so that it can be aligned after the module has been incorporated into a TO housing by way of example, in such a way that both the coupling-in efficiency and the coupling-out efficiency into and out of an optical waveguide can be optimized.

The bidirectional module is preferably integrated into a TO housing with a baseplate in such a way that the carrier is arranged perpendicular to the baseplate. This means, inter alia, that the module is placed onto the TO baseplate, connected there (e.g. with bonding wires or by means of soldering connections), and is then actively aligned and then encapsulated.

In an advantageous manner, the module is coupled to an optical waveguide via the light-shaping element such that a free-radiating region is formed between the module and the optical waveguide. An optical waveguide such as a fiber or else a fiber STUB may be used as the optical waveguide.

In one embodiment, the carrier has a second side and metallizations for electrical contact-connection of the receiver are formed on the second side of the carrier. The second side may be opposite the first side, by way of example. This reduces mutual influencing or interference of the electrical signals conducted to and from the module.

### BRIEF DESCRIPTION OF THE DRAWINGS

The invention is explained in more detail below on the basis of exemplary embodiments shown in the figures, in which:

FIGS. 1a and 1b show a perspective view of a bidirectional optoelectronic module with a shielding cap above the receiver;

FIG. 2 shows a plan view of a side of the bidirectional optoelectronic module of FIG. 1 on which the light transmitter and the receiver are arranged, in a schematic illustration;

FIG. 3 shows the opposite side of the opto-electronic bidirectional module from the side illustrated in FIG. 2;

FIG. 4a shows a plan view of a TO housing in which a bidirectional module with a perpendicularly arranged carrier plate is arranged and whose individual components are electrically contact-connected partly by means of bonding wires and partly by means of solder balls; and

FIG. 4b shows a plan view of a TO housing analogous to FIG. 4a, the individual components thereof being contact-connected only by means of solder balls.

### DESCRIPTION OF A PLURALITY OF PREFERRED EXEMPLARY EMBODIMENTS

In the figures, mutually corresponding or similar features have the same reference symbols.

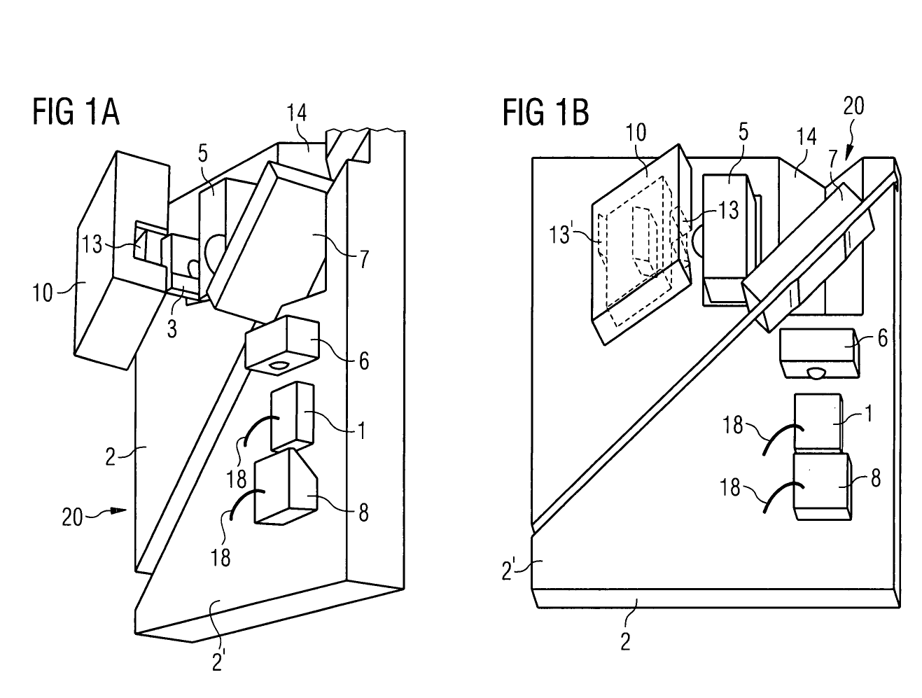

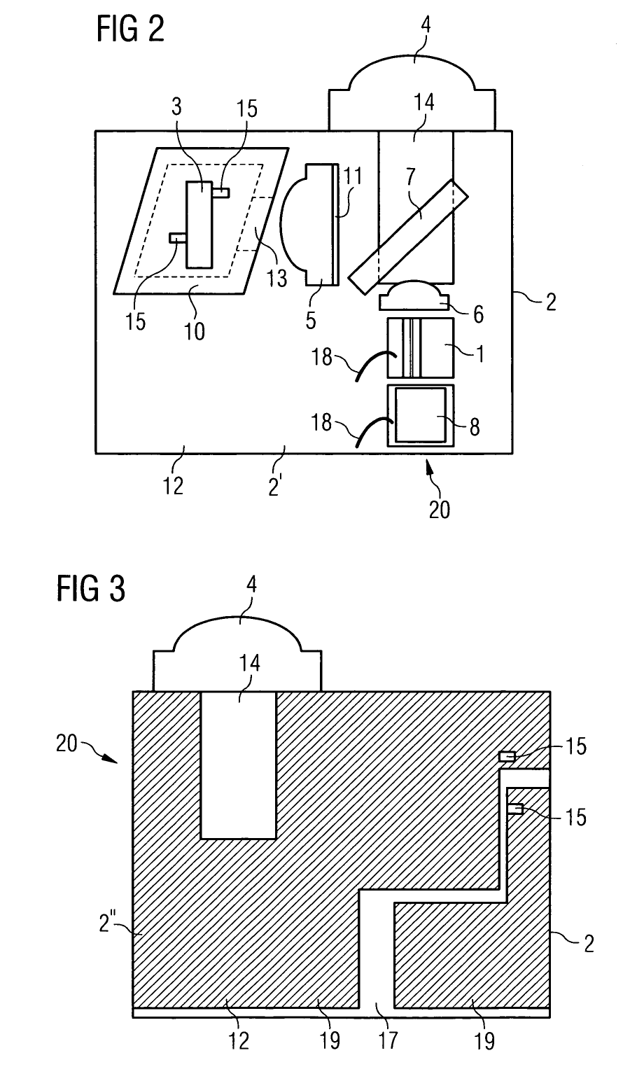

FIGS. 1a, 1b and 2 show a bidirectional electro-optical transmitting and receiving module 20. The module 20 has a basic carrier plate 2 as carrier, which is formed as a silicon submount, by way of example. All the essential components of the module 20 are arranged on one side, the top side 2′ illustrated in the figures, of the carrier 2.

A laser diode 1 serves as a light transmitter, whose signal output is recorded by the monitor diode 8. In the further beam course, light signals of the laser diode 1 are detracted by a transmitter microlens 6 and radiate through a wavelength-selective beam splitter 7 before the light signals are coupled out of the module without beam deflection through the microlens 4 (FIG. 2). Light signals that come from the coupling-out direction and are to be detected by the module 20 firstly pass through the microlens 4, are deflected by approximately 90° at the beam splitter 7 and focused onto the photodiode 3 as receiver by the receiver microlens 5.

FIG. 2 shows, as a first light-shaping element or as coupling means, the microlens 4, which is the only component not arranged on the first side 2′ of the carrier 2, but rather is arranged at a sawing edge at the end of the carrier 2, said sawing edge running at an angle of 90° with respect to the top side 2′. The microlens 4 has two tasks: Firstly, it couples light signals emerging from the arrangement 20 into an optical waveguide (not illustrated); secondly, light signals from precisely said optical waveguide radiate through said microlens, and are directed into the module 20 by the microlens 4. Consequently, the microlens 4 serves for coupling light signals into and out of the module and for coupling the light signals into and out of an optical waveguide (not illustrated).

In this case, the optical waveguide runs approximately in the plane of the top side 2′ of the carrier 2.

The laser diode 1 is formed as an edge emitting laser diode and emits laser signals essentially parallel to the first side 2′ of the carrier 2. In this case, the laser diode 1 is oriented in such a way that light signals emitted by it pass rectilinearly to the microlens 4 and from there at a squint angle into the optical waveguide (not illustrated).

Before the light signals reach the microlens 4, they pass through the light-shaping element—assigned to the light transmitter—in the form of light transmitter microlens 6, by which they are focused precisely onto the microlens 4. At the side opposite to the emission direction of the laser diode 1, a monitor diode 8 is arranged on the carrier plate 2, and records radiation which is emitted by the laser diode 1 in the opposite beam direction and makes up a fraction of the forward emitted radiation.

The photodiode 3 is furthermore arranged on the first side 2′ of the carrier 2, said photodiode serving as a receiver and being positioned in such a way that it detects incoming light signals from a direction running approximately perpendicular to the beam path of the light signals emitted by the light transmitter 1. A pin diode rotated through 90° is involved here, which is adhesively bonded onto the carrier 2 or soldered thereon by means of so-called “solder ball bumps”. Light signals to be received from the optical waveguide (not specifically illustrated) firstly pass through the microlens 4, are focused by the latter and transmitted along a grooved cutout 14 in the direction toward the laser diode 1. The beam splitter 7 inclined by 45° relative to the direction of incidence is situated in the beam path, which beam splitter may be formed e.g. as a WDM filter and deflects the light signals to be received by 90° in the direction of photodiode 3. What is involved in this case is e.g. a wavelength division multiplexer/demultiplexer which enables light having different wavelengths to be simultaneously coupled into and out of a fiber. The beam splitter 7 here separates the incoming from the outgoing light signals by virtue of the fact that it reflects only the incoming light signals by 90° and allows the outgoing light signals emitted by the laser diode 1 to be transmitted unimpeded. After reflection at the beam splitter 7, the light signals to be received pass through the receiver coupling means 5, which is formed as a receiver microlens. The receiver microlens 5 focuses the light signals to be detected directly onto an optically active area of the receiver photodiode 3.

A shielding means in the form of a rhomboid shielding cap 10 is slipped over the photodiode 3. The shielding cap 10 is composed e.g. of patterned silicon 110 and has in its interior a vapor-deposited or sputtered metal layer that acts as a Faraday cage. It thus keeps not only optical but also electrical interference signals away from the photodiode 3. The shielding cap 10 is opaque. The photodiode 3 is surrounded from all sides either by the shielding cap 10 or (on one side) by the carrier 2. The only opening through which electromagnetic waves can pass to the photodiode 3 is formed by an essentially square coupling-in opening 13. The coupling-in opening 13 is formed in a wall of the shielding cap 10 at the location that lies on the direct connecting line of the optically active area of the photodiode 3 and the receiver microlens 5. Light signals to be received which have been reflected from the beam splitter 7 to the receiver pass centrally through the coupling-in opening 13. Due to the dictates of production, a second opening 13′ is arranged on that side of the parallelogram—which shapes the shielding cap 10—which is opposite to the coupling-in opening 13. Said second opening 13′ is not necessary and is not desirable either, but is formed as a byproduct during the simultaneous sawing-out of the coupling-in openings into a plurality of shielding means by a single sawing process in the shielding means.

An optical filter 11 is arranged on that side of the receiver microlens 5 which is opposite to the photodiode 3. The optical filter 11 is arranged in the direct connecting line between the laser diode 1 and the coupling-in opening 13. The optical filter 11 reflects light having a wavelength which is emitted by the laser diode 1. Consequently, the filter 11 shields the coupling-in opening 13 from penetrating optical interference signals. In an alternative embodiment, provision may be made for introducing the filter 11 directly into the coupling-in opening 13.

The first side 2′ of the carrier 2 is completely protected by a blocking layer 12, which is opaque to any type of electromagnetic radiation. Consequently, electromagnetic radiation is prevented from penetrating into the carrier 2 and thereby possibly passing through to the photodiode 3 through reflection at the underside of the carrier 2 under the shielding means 10.

The photodiode 3 is connected to the rear side of the carrier 2 by means of metallic contacts (vias) 15 in order to relay the detected signals on the rear side (in this respect, cf. FIG. 3). As a result, although light transmitter 1 and receiver 3 are situated on one side of the carrier 2, their electrical connections are situated on different sides, so that the leads of the modulated signals do not mutually interfere with one another.

In the case of the bidirectional module 20 shown in the figures, the beam path of the light signals to be received, the beam path of the light signals to be transmitted, the beam path of the light signals to be coupled into the optical waveguide and the beam path of the light signals to be coupled out of the optical waveguide all lie in the same plane, here in the plane of the first side 2′ of the carrier 2. The microlens 4 is fixed directly on the carrier on which light transmitter 1 and receiver 3 are also arranged. All the microlenses used, that is to say microlens 4, light transmitter microlens 6 and receiver microlens 5, are produced from silicon. Instead of being produced from silicon, the microlenses used may also be produced from glass.

The way in which the shielding cap 10 formed in a rhomboid fashion is placed over the photodiode 3 can be seen particularly well in FIGS. 1a and 1b.

FIG. 3 shows the second side, the underside 2″, of the carrier 2, which is opposite to the first, top side 2′ shown in FIG. 2. Two plated-through holes (vias) lead the electrical contacts of the receiver to the underside 2″, on which metallizations 19 provide further electrical contacts. In particular, the metallizations may form an interface which is contact-connected to two TO pins in order to provide an electrical contact-connection between the TO pins and the photodiode 3. In this case, the metallizations 19 are formed in such a way that they cover the largest possible area of the underside and thereby shield it from electromagnetic radiation. Only between the contacts is there arranged a free region 17, in order to prevent mutual contact-connection.

In the same way as on the opposite side 2′, a blocking layer 12 may be provided between the metallic contacts 19 and the actual carrier 2, which blocking layer prevents electromagnetic scattered radiation from penetrating into the carrier 2. The blocking layer 12 is formed below the contacts 17 in order to minimize possible interactions or signal influencing.

As an alternative, it is also possible to metallize only that region of the surface 2′ of the carrier 2 on which the photodiode 3 is arranged and which is covered by the shielding cap 10.

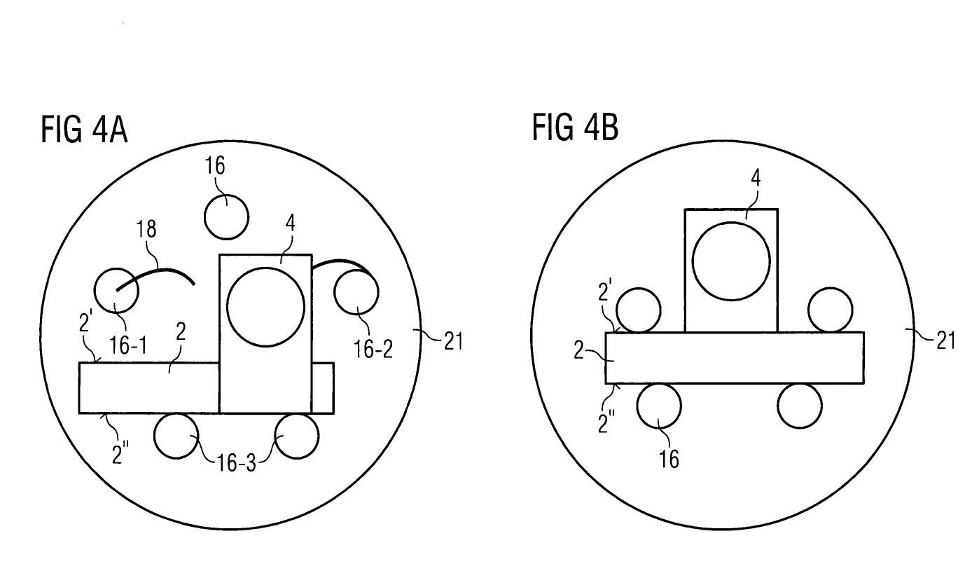

FIG. 4a shows, in a schematic illustration, a plan view of a bidirectional module that has already been inserted into a TO housing 21. The TO housing has a baseplate 21, through which a plurality of contact pins 16 project in a manner known per se. The carrier 2 with the optical components arranged on a side 2′ of the carrier is inserted into the TO housing perpendicularly to the baseplate. Signals are coupled out upwardly via the lens 4, the microlens 4 being fixed on the sawing edge of the carrier 2.

Consequently, in this illustration, the module 20 is rotated through 90° both with respect to FIG. 2 and with respect to FIG. 3 and plugged into the TO housing perpendicularly like a plug-in card. An imaging region of the microlens 4 projects beyond the sawing edge in the direction of the first side 2′ of the carrier 2, while light signals pass on the second side 2″, for which reason here there is no need for an imaging region of the microlens 4. The components arranged on the first side 2′, such as laser diode 1 and photodiode 3 (cf. FIGS. 1a, 1b and 2), are not illustrated in FIG. 4a.

The electrooptical components on the one side 2′ of the carrier, in particular the laser diode and the receiver, are connected to the contact pins by means of bonding wires or soldering contacts (solder ball bumps). By way of example, in FIG. 4a, the two contact pins 16-3 and 16-4 are connected directly to the underside 2″ of the carrier by means of solder ball bumps, a contact-connection of the receiver being provided in accordance with FIG. 3. Further contact pins 16-1 and 16-2 are electrically connected to further components by means of schematically illustrated bonding wires 18.

In the exemplary embodiment of FIG. 4b, contact-connection is effected exclusively by means of solder ball bumps. It is advantageous that the contact-connections for the laser diode 1 and the photodiode 3 are positioned on mutually opposite sides of the carrier plate 2.

During assembly, firstly the electrooptical module 20 as illustrated in FIGS. 1a and 1b (that is to say without microlens 4) is inserted into a TO housing 21 such as from FIGS. 4a and 4b. In this case, the carrier 2 is arranged with its planar side in the signal transmission direction. Only after contact-connection with bonding wires 18 and/or solder ball bumps 16 is the microlens 4 applied to the sawing edge of the carrier 2. The microlens 4 is thus not aligned until after the carrier 2 (as a silicon bench) has been applied to the TO header. The subsequent alignment of the microlens permits alignment of the incoming and outgoing beam path relative to the optical waveguide.

In an alternative embodiment, the shielding cap 10 is made of metal, for example an injection-molded MIM part. The bidirectional optoelectronic module need not be incorporated into a standard TO platform, but rather can also be used differently, preferably in the form of a hermetic package with pins.

The structures in the silicon may be produced both isotropically and anisotropically.

List of Reference Symbols

| | |
|---|---|
| 1 | Light transmitter |
| 2 | Carrier |
| 2′ | First side of the carrier |
| 2′′ | Second side of the carrier |
| 3 | Photodiode |
| 4 | Microlens |
| 5 | Receiver microlens |
| 6 | Light transmitter microlens |
| 7 | Beam splitter |
| 8 | Monitor diode |
| 10 | Shielding means |
| 11 | Optical filter |
| 12 | Blocking layer |
| 13 | Coupling-in opening |
| 14 | Cutout |
| 15 | Conductor |
| 16 | TO pins |
| 17 | Free region |
| 18 | Bonding wires |
| 19 | Contacts |
| 20 | Bidirectional module |
| 21 | TO housing |

1-26. (canceled)

27. An optoelectronic module for coupling light signals into and out of an optical waveguide, comprising:
a carrier having at least a first side;
a light transmitter configured to emit light signals, and arranged on the carrier;
a receiver configured to detect light signals, and arranged on the carrier;
a first light-shaping element configured to couple light signals of the light transmitter out of the module and couple light signals into the receiver; and
a shielding means configured to shield the receiver from optical or electrical interference signals,
wherein the light transmitter and the receiver are both arranged on the first side of the carrier.

28. The module of claim 27, wherein the shielding means comprises a separate component arranged on the carrier.

29. The module of claim 28, wherein the shielding means comprises a housing placed onto the first side of the carrier and surrounding the receiver.

30. The module of claim 27, wherein the shielding means comprises a silicon structure formed by the process of micromechanical etching.

31. The module of claim 27, wherein the shielding means comprises a hollow structure that, upon the shielding means being arranged on the first side of the carrier, defines a three-dimensional spatial region surrounding the receiver.

32. The module of claim 27, wherein the shielding means comprises a Faraday cage, wherein the receiver is arranged within the Faraday cage.

33. The module of claim 32, wherein at least an inner surface of the shielding means is metallized.

34. The module of claim 27, wherein the shielding means comprises at least one coupling-in opening through which light signals from the first light-shaping element are coupled into the receiver.

35. The module of claim 27, further comprising a second light-shaping element arranged in a beam path between the first light-shaping element and the receiver, wherein the second light-shaping element couples light signals passing from the first light-shaping element onto an optically active area of the receiver.

36. The module of claim 35, wherein the second light-shaping element comprises an optical filter on a side thereof opposite the receiver, wherein the optical filter is configured to shield scattered light from the light transmitter from the receiver.

37. The module of claim 27, further comprising an optically nontransparent layer overlying at least one side of the carrier.

38. The module of claim 27, wherein all the components of the module that are employed for coupling light signals in and out are of the module are arranged on the first side of the carrier except for the first light-shaping element.

39. The module of claim 27, wherein the first light-shaping element is arranged on an end side of the carrier.

40. The module of claim 39, further comprising a cutout formed in the first side of the carrier in a manner adjoining the first light-shaping element.

41. The module of claim 27, wherein the light transmitter is arranged on the first side of the carrier such that a beam path associated therewith runs rectilinearly between the light transmitter and the first light-shaping element.

42. The module of claim 27, wherein the light transmitter transmits light having a first wavelength and the receiver detects light having a second, different wavelength, the module further comprising a wavelength-selective beam splitter arranged on the first side of the carrier, and configured to reflect either the emitted first wavelength or the received second wavelength, wherein the light transmitter and the receiver are arranged on the first side of the carrier such that beam paths associated therewith run at an angle of about 85° to about 95° with respect to one another at the location of the beam splitter.

43. The module of claim 42, wherein the beam splitter is arranged in a groove on the first side of the carrier.

44. The module of claim 27, wherein the first light-shaping element comprises a microlens.

45. The module of claim 27, the carrier comprising a second side opposite the first side, the second side comprising one or more metallizations, the carrier further comprising one or more conducting vias extending therethrough and configured to provide an electrical contact-connection of the receiver to one or more metallizations, respectively, on the second side of the carrier.

46. An optoelectronic transceiver, comprising:
a carrier comprising a first side, a second side opposite the first side, and an end side extending between the first and second sides;
an optical transmitting component residing on the first side of the carrier and configured to transmit outgoing optical signals having a first frequency along a first optical axis;
an optical receiving component residing on the first side of the carrier and configured to detect incoming optical signals having a second, different frequency along a second optical axis, wherein the first and second optical axes are non-parallel;
a first light-shaping component abutting the end side of the carrier and configured to couple incoming optical signals to the optical receiving component and couple outgoing optical signals from the optical transmitting component, respectively;
a beam splitter component arranged on the first side of the carrier at an intersection of the first and second optical axes, and configured to direct incoming optical signals having the first frequency from the first light-shaping component along the first axis, and direct outgoing optical signals having the second frequency from the optical transmitting component toward the first light-shaping component along a third axis; and
a shield structure having a cut-out associated therewith arranged on the first side of the carrier and covering the optical receiving component, wherein the cut-out is aligned with respect to the second optical axis to allow incoming optical signals to pass from the beam splitter component to the optical receiving component, wherein the shield structure is configured to shield the optical receiving component from optical or electrical interference signals.
